(19) United States
(12) Patent Application Publication
(10) Pub. No.: US 2021/0123608 A1
(43) Pub. Date: Apr. 29, 2021

(54) METHOD FOR THERMAL ENERGY TRANSMISSION USING WATER AND CARBON DIOXIDE

(71) Applicant: M.E.D. Energy Inc., Monsey, NY (US)

(72) Inventors: Francois Ignace Geinoz, Bulle (CH); Marcel Cueni, Bulle (CH); Kameran Yakob, Carouge (CH)

(73) Assignee: M.E.D. Energy Inc., Monsey, NY (US)

(21) Appl. No.: 16/663,954

(22) Filed: Oct. 25, 2019

(51) Int. Cl. F24D 10/00; F24D 3/08

(52) U.S. Cl. CPC F24D 10/006; F24D 2200/16; F24D 3/08

(57) ABSTRACT

The invention provides a system for energy distribution that uses liquid carbon dioxide as a working fluid. Evaporation of the carbon dioxide provides cooling, and compression of the carbon dioxide gas back to the liquid state provides heat. The amount of heat transferred at both stages is sufficient to provide environmental heating and cooling. Waste thermal energy from a power plant, in the form of hot water, is fed into the system and used to drive the overall process. An underground thermal energy storage system is used to store energy flowing into the system that is in excess of the current demand.

### RELATED APPLICATIONS

There are no related or priority applications.

### FIELD OF THE INVENTION

The invention is in the general field of energy transmission and delivery. More particularly, the invention relates to co-transmission and co-delivery of both heating and cooling capacities on an as-needed basis.

### BACKGROUND OF THE INVENTION

Generating stations for electricity production produce thermal energy in very large quantities. Depending on the nature of the fuel and the design of the plant, the thermal energy dissipated (co-generated) during the production of electrical energy may range from 35 to 65%. Although it is relatively easy to deliver the generated electricity to end consumers, it is much more difficult to deliver the co-generated thermal energy to potential consumers.

Thermal energy production by co-generation is not readily matched with demand, because it is a function of electricity production, and it is difficult to store thermal energy in commercially significant quantities. Furthermore, thermal energy losses are considerable during transmission, particularly in the case of remote destinations where losses can exceed 50% of the energy produced. Energy losses can be reduced with effective insulation, but the cost of such insulation increases more rapidly than its effectiveness. For these reasons, the delivery of centrally-generated thermal energy is largely restricted to dense urban areas, such as New York City and Chicago, where the local electric utility can economically deliver co-generated steam to customers via underground piping.

Customers requiring cooling can use steam to power vapor compression or absorption refrigeration chillers, but these are economical only for the large-scale installations found in office towers and apartment buildings. Smaller residential and commercial customers rely on the electrical grid to power vapor-compression air conditioners, and in very hot weather this can strain the local grid to the point of managed brownouts or unplanned failure. A method of distributing chilled water, known as district cooling, is possible where lake, river or sea water is available as a heat sink, but it requires installation of a second, parallel distribution system for delivery of the chilled water.

Given the above difficulties, there remains a need for an economical and efficient method of transmitting co-generated thermal energy, particularly over long distances.

### BRIEF DESCRIPTION OF THE INVENTION

This invention overcomes the above-mentioned disadvantages by producing, transmitting and delivering to end-users a supply of thermal energy using moderately heated water as a heat carrier, and another fluid carrying mechanical energy transformable into thermal energy—liquid carbon dioxide under high pressure, in the order of 50 atmospheres—for cold production and inversely transformable into mechanical energy for heat production.

To obtain cooling, the end user allows the liquid carbon dioxide to evaporate, thereby removing from a local heat exchanger the heat of vaporization of the carbon dioxide. Adiabatic expansion of the gas can be used to obtain further cooling.

The expanded gas is then warmed by the heated water. To obtain heat, the end user adiabatically compresses, liquefies and cools the warmed gas, and the generated heat is provided to a heat exchanger. The carbon dioxide is returned to the system. In a preferred embodiment of the invention, these processes are supplemented by energy that is retrieved from an in-ground thermal energy storage system and delivered by the circulating water.

Under pressure, carbon dioxide can remain in the liquid state at moderate temperatures below the critical temperature of 31° C. The pressure is preferably such that the carbon dioxide remains liquid in the temperature range of 4° C. to 15° C., which corresponds to the average temperature of most soils in the world below a depth of 1.5 meters. Under these conditions, the liquid carbon dioxide is capable of being transported by underground pipe over long distances, with energy losses limited to the pumping required to compensate for pressure drops over distance. At its destination, expansion of the carbon dioxide provides both mechanical energy and cooling.

The water that carries the bulk of the thermal energy is maintained at its working temperature by thermal exchange with the surrounding soil, which, once heated, serves as a high-capacity energy storage medium. The system of the invention allows a high percentage of the thermal co-generated thermal energy to be supplied to end customers ala carte, i.e., according to consumer demand for cooling and/or heating, over considerably longer distances than are practical with prior art steam distribution systems.

### BRIEF DESCRIPTION OF THE DRAWINGS

FIG. 1 shows an overall view of a distribution system of the invention.

FIG. 2 shows an inlet connection chamber for entering water.

FIG. 3 shows a carbon dioxide injection chamber.

FIG. 4 shows an outlet connection chamber for discharged water.

FIG. 5 shows an injection chamber coupled to a carbon dioxide recovery chamber.

FIG. 6 shows a ground-coupled heat exchanger for incoming hot water.

FIG. 7 shows a ground-coupled heat exchanger for cooled water.

### DETAILED DESCRIPTION OF THE INVENTION

The process of the invention begins at an energy production facility adapted for co-generation of electrical and thermal energy. The facility is preferably a waste-to-energy conversion plant, in which pyrolysis or gasification of waste is carried out at high temperatures and pressures, so that separated carbon dioxide at an intermediate or high pressure is directly available from the electricity generating process itself. A combustion-based plant can be used if it is provided with carbon dioxide capture, or with an external supply of carbon dioxide. Power required to compress the carbon dioxide to a liquid state is preferably supplied by the electrical output of the plant, with heat released by the compression and condensation contributing to the co-generated thermal output.

The transport of the carbon dioxide to the end users is carried out via pipe, with the carbon dioxide in liquid form at a density of about 763 kg/m³ at room temperature. This is over 400 times higher than the density of carbon dioxide under normal conditions, (NTP, 20° C. and 1 bar), which is 1.80 kg/m³. The pipe is buried underground, at a depth of at least 1.5 m, and preferably 2.0 m or more. The piping, at this depth, is provided with little or no insulation, because ambient soil temperature maintains a temperature of 4° C. to 15° C. in most developed areas of the world. A pressure sufficient to maintain the boiling point of carbon dioxide below that range (ca. 50 atm at 15° C.) is maintained throughout the carbon dioxide piping system. The piping is preferably of a relatively small diameter (10 cm or less), in view of the need to reliably and cost-effectively contain the carbon dioxide at such pressures. The pressure, which is on the order of 50 atm, can be varied to accommodate the local soil temperature, and seasonally adjusted if necessary. “Hot spots”, e.g. where the piping is exposed to the sun or is not at its full running depth, are provided with insulation and/or cooling.

Broadly, the invention provides a method for distributing energy from a thermal energy source to the site of a customer in need of heating and cooling, which comprises generating, at the thermal energy source, carbon dioxide in liquid form, at a temperature between about 4° C. and about 15° C., under a pressure sufficient to maintain the carbon dioxide in a liquid state at that temperature. The method comprises the further step of generating, at the thermal energy source, hot water at a temperature of at least 30° C. The liquid carbon dioxide and the hot water are then piped to the site where they will be used.

At the site, the liquid carbon dioxide is evaporated to carbon dioxide gas to provide cooling. The resulting gaseous carbon dioxide is then allowed to expand, and is warmed with the hot water. Preferably, the carbon dioxide is injected directly into the water to effect a rapid and efficient transfer of thermal energy. The warmed gas is then compressed, condensed, and cooled to the initial conditions described above. The rejected heat from this process is used to provide heating at the site.

In a preferred embodiment, the method is rendered more efficient, and more capable of meeting peak demand, by incorporation of a thermal energy storage system. Seasonal energy storage systems, as are known in the art, are particularly suitable for storage of large quantities of moderate-temperature thermal energy, and all such systems are contemplated to be within the scope of the invention. A ground-coupled heat exchanger is one example of seasonal storage system, and this particular embodiment is described, by way of example, below and in the drawings. The use of the exchanger calls for injecting the hot water into a water-filled loop, in which the water is being circulated around the loop. The water in the loop is warmed by the injected hot water, and then passes through a first portion of a seasonal thermal energy storage system. The first portion is configured and operated so as to cool the water to a temperature between 4° C. and 15° C. The water exiting the exchanger is contacted with adiabatically expanding carbon dioxide gas, which chills the water and warms the gas. This contacting step is preferably carried out by injection of the gas into the water.

The water is then separated from undissolved carbon dioxide gas. A portion of the water is discharged from the loop, at a rate equal to the rate of injection of the hot water. The cooled water is then passed through a second portion of a seasonal thermal energy storage system, which is configured and operated so as to warm the water back to a temperature between 4° C. and 15° C. The water is then returned to the point of hot water injection, so as to close the loop.

Depending on its design, a 5 MW electricity generating plant will also produce on the order of 2.5 MW of thermal energy, which in the present invention is carried off as hot water in an insulated pipe. Piping having a diameter of ca. 250 mm is sufficient to carry this load. Because the water is at a moderate temperature (30° C. to 90° C.), the level of insulation is far less than what is required for steam distribution.

The mechanical energy transported by a 100 mm pipe filled with liquid carbon dioxide at 50 atm, and circulating at 10-20 l/s at full capacity, is about 4 MW. Ten l/s of liquid carbon dioxide corresponds to the production of carbon dioxide in a power plant of about 50 MW.

The carbon dioxide not injected into the water recirculates in the carbon dioxide return pipe to its full capacity of 10 to 20 l/s. Thus, thanks to the accumulation of carbon dioxide within the carbon dioxide loop, the full power of stored mechanical energy is reached regardless of the power plant's capacity.

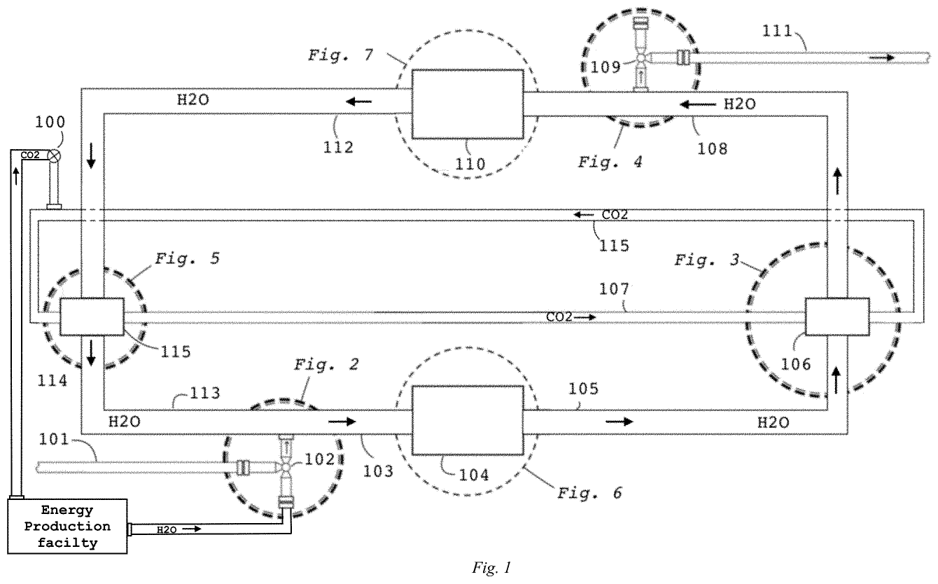

Turning to the drawings, the operation of the system of the invention is now described. FIG. 1 is an overall schematic of a water loop of the system. A number of such loops may be present along the length of the carbon dioxide and water pipelines that lead from the power plant. Each loop may serve a large apartment complex or neighborhood, a retail center, an office or industrial park, or even an entire town if scaled appropriately.

Liquid carbon dioxide, under a pressure of about 50 atm, is metered into the system at 100. The liquid carbon dioxide flows in a loop through pipes 107 and 115. Carbon dioxide is gradually lost through water outlet 111, as detailed below, and the amount metered in at 100 maintains the circulating volume and also maintains the pressure.

The warm water output of a previous loop, if any, enters at 101. Hot water from the power plant is metered into the loop at inlet connection chamber 102, and the combined flow is carried by pipe 103 to the first ground-coupled heat exchanger 104. Heat flows into the soil, which serves as a high-capacity reservoir for low-intensity thermal energy. Water exits the exchanger at 105 and feeds into carbon dioxide injector 106. Carbon dioxide at 50 atm enters the injector via pipe 107. The operation of the injector is described below.

Water exits injector 106 via pipe 108, from which it may be drawn off at outlet connection chamber 109 and passed on via pipe 111 to the next loop in the line. Water not drawn off is fed to a second water-soil heat exchanger 110. The heat exchangers are located in close proximity underground, so that the soil warmed by exchanger 104 transfers heat back to the water in exchanger 110. The warmed water exits through pipe 112 and flows to the carbon dioxide recovery unit 115. Liquid carbon dioxide at 50 atm, from the power plant or from a previous loop, enters the recovery unit at 114. Operation of the recovery unit is described below. Carbon dioxide recovered by the unit is returned to the carbon dioxide pipe 107, and the water leaves via pipe 113 and returns to the first heat exchanger 104, completing the loop.

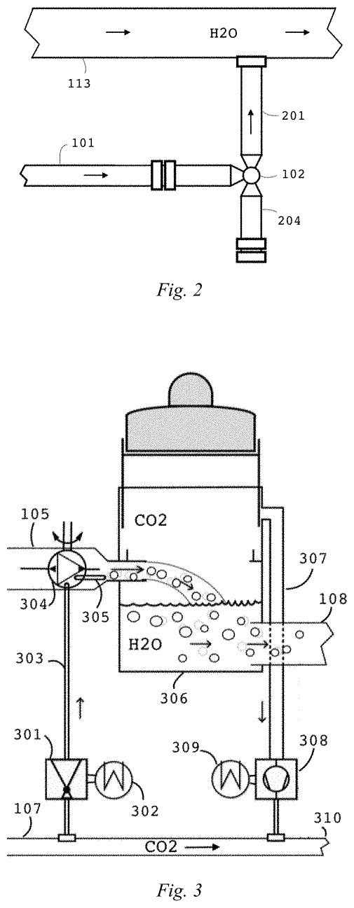

Turning to FIG. 2, the inlet connection chamber is shown in enlarged form. Inlet 204 carries hot water from the power plant, which is merged at chamber 102 with water from any previous loop, which is incoming through pipe 101. The merged flow, having been heated by the incoming hot water, preferably to a temperature in excess of 30° C., enters the pipe 113 through connector 201 and passes to ground-coupled heat exchanger 104 (FIG. 1), where it will warm the surrounding soil, which serves as the thermal energy storage for the loop.

Turning to FIG. 3, the operation of the carbon dioxide injector will now be described. Water exiting the heat exchanger 104 (FIG. 1) at about 12° C. to 15° C. enters the injector at 105. A portion of the liquid carbon dioxide at 50 atm, carried by pipe 107, is vaporized through expansion chamber 301 and the expanding gas is delivered by pipe 303 to a turbine-driven water pump 304 before being injected at 305 into the water stream. The pump 304 contributes to the circulation of the water in the loop. The water and entrained carbon dioxide enter the phase separation chamber 106 where the carbon dioxide is taken off through outlet 307. The carbon dioxide is compressed and liquefied by compressor 308 and returned to the pipe 107, before exiting at 310 and passing to return pipe 115.

The chamber 306 is maintained at a pressure of 1 to 2 atm, and the water that exits at 108 will contain dissolved carbon dioxide at a concentration ranging from about 1 g/liter to about 3 g/liter, depending on the precise pressure and temperature.

The evaporation of the carbon dioxide in chamber 301 is accompanied by considerable cooling (the heat of vaporization of carbon dioxide is ca. 7700 J/mol at 50 atm.) Heat exchanger 302 provides the heat needed to maintain the evaporation rate, and the chilled heat transfer fluid is used to provide cooling to the users of the system, for example to cool a central air conditioning system. Conversely, at 308, the compression of the gas to 50 atm and subsequent liquefication releases a comparable amount of heat. Heat exchanger 309 recovers this heat for use in heating air and water for the users, and a portion of the energy required to power the compressor is thereby put to use (the remainder is stored in the form of liquid carbon dioxide.) The adiabatic expansion of the carbon dioxide as it passes through the turbine at 304 is also accompanied by cooling, and the water exiting at 108 will be cooled accordingly, its thermal energy having thus been transferred to the carbon dioxide.

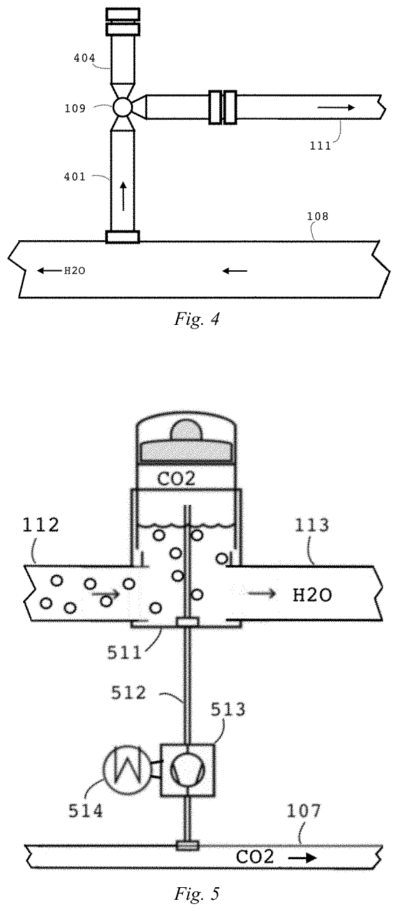

Turning to FIG. 4, the outlet connection chamber is shown in greater detail. A portion of the carbonated, cooled water entering pipe 108 may be drawn off through connector 401 and delivered to the exit pipe 111 via connection chamber 109. The water not drawn off passes to ground-coupled heat exchanger 110, where it will be warmed back to the working temperature of about 12° C. to 15° C. by drawing heat from the soil, which has been warmed by ground-coupled heat exchanger 104.

Turning now to FIG. 5, a carbon dioxide recovery unit is shown in detail. The recovery unit serves to collect carbon dioxide bubbles that arise within the system due to local variations in water pressure and temperature. Carbonated water flowing through pipe 112 enters carbon dioxide recovery chamber 511, where the gas and liquid phases separate. Carbon dioxide passes through pipe 512 to compressor 513, where it is compressed to about 50 atm and liquefied before being returned to carbon dioxide pipe 107. Heat released by the compression and condensation is recovered for use by heat exchanger 514. The water, now largely decarbonated, passes out through pipe 113 to be mixed with hot water from the power plant, before being returned to ground-coupled heat exchanger 104, thus completing the loop. The location of the chamber is not critical, but high points, where gas is likely to accumulate, are preferable, and a number of chambers may be employed.

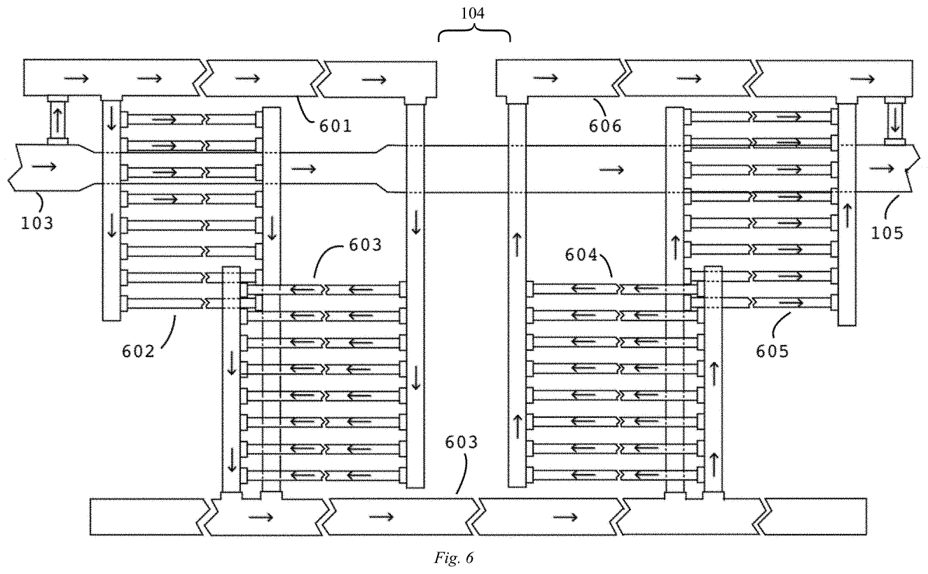

Turning to FIG. 6, a representative ground-coupled heat exchanger 104 is illustrated. Warm water enters at 103, and flows into manifold 601. When necessary, for example if the soil temperature is too warm for efficient heat transfer, water can be diverted directly to exit 105 by a valve (not shown). In the embodiment shown, two racks of heat exchange pipes 602 and 603 are embedded in and in effective thermal contact with the soil, at least 1.5 m but preferably at least 2.0 m below the surface. The depth will be appropriate to the climate where the system is installed. In this embodiment, water then flows to a second manifold 603, and then to a second set of heat exchange pipes 604 and 605, likewise embedded in the soil. Water exiting these pipes is collected by manifold 606 and directed to outlet 105.

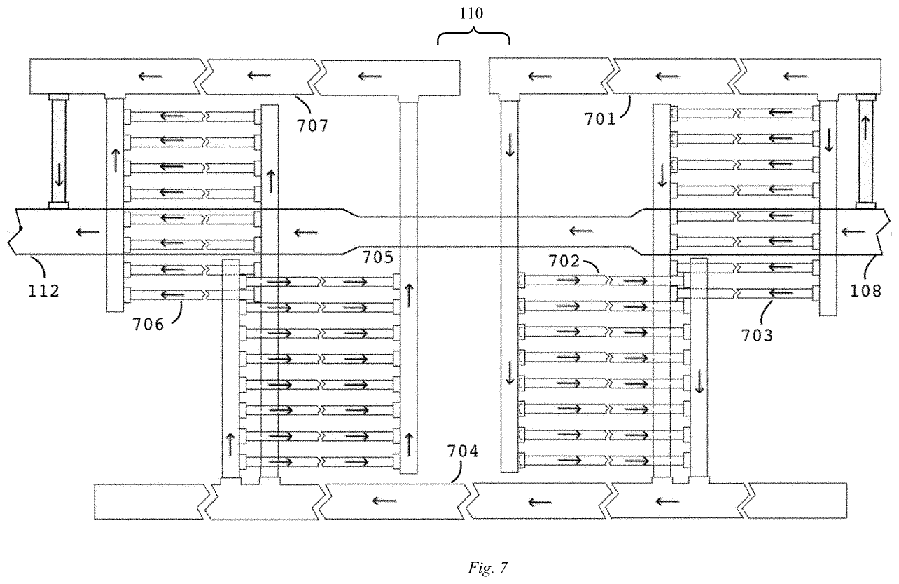

Turning to FIG. 7, a similar representative ground-coupled heat exchanger 110 is shown. Cool water enters at 108, and flows into manifold 701. When necessary, water can be diverted directly to exit 112 by a valve (not shown). In the embodiment shown, two racks of heat exchange pipes 702 and 703 are embedded in and in effective thermal contact with the soil, at a depth appropriate to the climate where the system is installed. In this embodiment, water then flows to a second manifold 704, and then to a second set of heat exchange pipes 705 and 706, likewise embedded in the soil. Water exiting these pipes is collected by manifold 707 and directed to outlet 112.

The ground-coupled heat exchangers 104 and 110 are installed in close proximity underground, for maximum efficiency of heat transfer from one to the other. In a moderate climate they may be installed horizontally (parallel to the ground), while in extreme climates it may be desirable to install them vertically, to minimize exposure to excessively hot or cold soil.

It is expected that a plurality of loops according to FIG. 1 will be distributed along the length of the hot water and carbon dioxide pipelines. At the last such loop, the carbonated water effluent exiting at 111 is preferably directed to agricultural irrigation. Carbonated water can also be drawn off, if desired, at intermediate loops, limited only by the maximum flow rate of water through the system.

In particular, underground irrigation with carbonated water leads to direct uptake of the carbon dioxide by the irrigated plants, and atmospheric release of carbon dioxide is thereby reduced. An enhanced effect can be obtained within greenhouses. Significant improvements in crop growth have been demonstrated in tests of carbonated irrigation, but to date there has been no economical source of carbon dioxide at the necessary scale. The present invention can provide just such a source. Where the carbon dioxide used in the system is recovered from an oxidative electrical generation process, the net result is capture and sequestration, which is highly desirable as a means of mitigating anthropogenic climate change.

In another aspect, the invention provides, as described in detail above, a system for distributing thermal energy from a thermal energy source to the site of a customer in need of heating and cooling. The system of the invention comprises apparatus for generating carbon dioxide in liquid form, at a temperature between about 4° C. and about 15° C., under a pressure sufficient to maintain the carbon dioxide in a liquid state at that temperature; apparatus for providing hot water at a temperature of at least 30° C.; a system of pipes configured to deliver the liquid carbon dioxide to the site; a system of pipes configured to deliver the hot water to the site; an evaporator for evaporating the liquid carbon dioxide to carbon dioxide gas; a heat exchanger in thermal contact with the evaporator, adapted to provide cooling at the site; apparatus for allowing the carbon dioxide gas thus produced to expand; apparatus for thermally or physically contacting the expanded carbon dioxide with the hot water; a compressor adapted to condense and cool the vaporized carbon dioxide to the conditions recited in step (a); and a heat exchanger in thermal contact with the compressor, adapted to provide heating at the site. In a preferred embodiment, the system further comprises an energy storage system, more preferably a seasonal energy storage system.

The entire system acts in some respects like a large vapor-compression refrigeration system, with R744 (carbon dioxide) as the working fluid. Heat is absorbed where the carbon dioxide evaporates, and heat is released where the carbon dioxide is compressed. Both heat flows generate temperature differentials useful for environmental heating and cooling. Energy to drive the system is ultimately derived from hot water carrying waste heat from a power plant, and to a lesser extent from evaporation, expansion, and dissolution of the carbon dioxide, through which the energy used to compress it is recovered by the user. Because the temperatures at which the water is used are not extreme, insulation is less essential, and the thermal energy is readily stored by means of underground thermal energy storage.

In alternative embodiments, where the appropriate local geology exists, an aquifer thermal energy storage system, a borehole thermal energy system, any other form of seasonal thermal energy storage (STES) can be employed in place of the soil thermal storage system illustrated.

1. A method for distributing energy from an energy production facility to a site of a customer in need of heating and cooling, comprising:
(a) generating, at the energy production facility, carbon dioxide in liquid form, at a temperature between about 4° C. and about 15° C., under a pressure sufficient to maintain the carbon dioxide in a liquid state at that temperature;
(b) generating, at the energy production facility, hot water at a temperature of at least 30° C.;
(c) piping the liquid carbon dioxide and the hot water to the site;
(d) evaporating the liquid carbon dioxide to carbon dioxide gas to provide cooling at the site;
(e) allowing the evaporated carbon dioxide to expand;
(f) warming the expanded carbon dioxide with the hot water; and
(g) compressing, condensing and cooling the vaporized carbon dioxide to the conditions recited in step (a), and using the rejected heat to provide heating at the site.

2. The method for distributing thermal energy according to claim 1, wherein the expanded carbon dioxide is warmed by injecting it into the hot water.

3. The method for distributing thermal energy according to claim 2, further comprising:
(h) injecting the hot water into a water-filled loop, in which the water is being circulated around the loop;
wherein the water within the loop
(i) is warmed by the injected hot water;
(ii) passes through a first portion of a seasonal thermal energy storage system, the first portion being configured and operated so as to cool the water to a temperature between 4° C. and 15° C.;
(iii) is contacted with and cooled by adiabatically expanding carbon dioxide gas;
(iv) is separated from undissolved carbon dioxide gas;
(v) is partially discharged from the loop, at a rate equal to the rate of injection of the hot water;
(vi) passes through a second portion of the seasonal thermal energy storage system, the second portion being configured and operated so as to warm the water to between 4° C. and 15° C.; and
(vii) is returned to step (i).

4. A system for distributing thermal energy from an energy production facility to a site of a customer in need of heating and cooling, comprising:
(a) a system of pipes configured to deliver liquid carbon dioxide at a temperature between about 4° C. and about 15° C., under a pressure sufficient to maintain the carbon dioxide in a liquid state at that temperature, to the site;
(b) a system of pipes configured to deliver hot water at a temperature of at least 30° C. to the site;
(c) an evaporator for evaporating the liquid carbon dioxide to carbon dioxide gas;
(d) a heat exchanger in thermal contact with the evaporator, adapted to provide cooling at the site;
(e) an expansion chamber for allowing the carbon dioxide gas thus produced to expand;
(f) a heat exchanger which thermally or physically contacts the expanded carbon dioxide with the hot water;
(g) a compressor adapted to condense and cool the vaporized carbon dioxide to the conditions recited in step (a); and
(h) a heat exchanger in thermal contact with the compressor, adapted to provide heating at the site.
